(19) United States
(12) Patent Application Publication
(10) Pub. No.: US 2009/0201520 A1
(43) Pub. Date: Aug. 13, 2009

(54) Image Processing for Determining Dot Formation States in Printing an Image

(75) Inventors: Masaki HAYASHI, Shiojiri-shi (JP); Nobuhiro KARITO, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/365,768

(22) Filed: Feb. 4, 2009

(30) Foreign Application Priority Data
Feb. 12, 2008 (JP) 2008-030586

(51) Int. Cl. H04N 1/60

(52) U.S. Cl. 358/1.9

(57) ABSTRACT

An image processing apparatus for determining formation states of dots in printing an image based on an image data using dots of a plurality of sizes includes a storage and a dot formation state determination unit. The storage stores a width correspondence table that indicates correspondence relationships between a plurality of dot sequences representing combinations of dots of specific color along a prescribed direction, and width along the prescribed direction of dot areas composed of dots that are formed on a printing medium in accordance with the dot sequences. The dot formation state determination unit determines formation states of the dots based on the correspondence relationships indicated in the width correspondence table.

### CROSS REFERENCE TO RELATED APPLICATIONS

The present application claims the priority based on a Japanese Patent Application No. 2008-30586 filed on Feb. 12, 2008, the disclosure of which is hereby incorporated by reference in its entirety.

### BACKGROUND

1. Technical Field

The present invention relates to an imaging processing for determining dot formation states in printing an image.

2. Description of Related Art

Ink-jet printers enjoy widespread use as printing devices adapted to print images through a process of forming dots. An ink-jet printer prints an image onto a printing medium such as printing paper by jetting various colors of ink, for example, cyan (C), magenta (M), yellow (Y), and black (K), onto the printing medium. Certain ink-jet printers are capable of producing dots of several sizes, for example, large dots (L dots), medium dots (M dots), and small dots (S dots).

In printing an image by an ink-jet printer using dots of several different sizes, in typical practice, a process for determining states of dot formation on each printing pixel (termed a halftone process) on the basis of image data is carried out. Here, the determination as to the state of dot formation on each printing pixel refers to the determination as to what color and size of dot to form (or whether to form no dot) on each printing pixel.

Techniques adapted to reduce ink bleeding in border sections of certain areas of an image by thinning out dots located in border sections or reducing dot size at these locations during determination of states of dot formation are known.

For example, where an original document that includes text and graphics (hereinafter collectively referred to as “linear images”) is scanned by a scanner then printed out by an ink-jet printer on the basis of the scanned image data, owing to problems such as optical blur of the scanner or ink bleed it has proven difficult for width at each location of linear images in the original to be reproduced accurately in the printed image. The conventional techniques are directed to reducing blur in contour sections in certain areas of an image, and there are no currently known techniques for ensuring that areas composed of dots in the image are in fact reproduced with the desired width.

This sort of problem is not limited to printing by an ink-jet printer based on scanned image data that has been generated by scanning an original that contains linear images; rather, it is a problem common to instances where images are printed using dots of several different sizes.

### SUMMARY

An object of the present invention is to provide a technology whereby in printing an image using dots of several different sizes, it is possible to ensure that width of areas in the image composed of dots is the desired width.

In one aspect of the present invention, there is provided an image processing apparatus for determining formation states of dots in printing an image based on an image data using dots of a plurality of sizes. The image processing apparatus comprises a storage and a dot formation state determination unit. The storage stores a width correspondence table that indicates correspondence relationships between a plurality of dot sequences representing combinations of dots of specific color along a prescribed direction, and width along the prescribed direction of dot areas composed of dots that are formed on a printing medium in accordance with the dot sequences. The dot formation state determination unit determines formation states of the dots based on the correspondence relationships indicated in the width correspondence table.

According to this image processing apparatus, the width correspondence table indicating correspondence relationships between a plurality of dot sequences and width of dot areas is stored and formation states of the dots are determined based on the correspondence relationships indicated in the width correspondence table. Consequently, in printing an image using dots of several different sizes, it is possible to ensure that width of areas in the image composed of dots is the desired width,

The present invention can be realized in various aspects. For example, the present invention can be realized in aspects such as an image processing method and associated apparatus, a formation status of dots determination method and associated apparatus, a dot data generation method and associated apparatus, a printing data generation method and associated apparatus, a printing method and associated apparatus, a computer program that executes the functions of these methods and apparatuses, a recording medium on which such computer program is recorded, a computer program product that includes this recording medium, or a data signal encoded in a carrier wave that incorporates this computer program.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is an illustration depicting schematically a configuration of a printing system according to an embodiment of the present invention;

FIG. 2 is an illustration depicting exemplary content of a width correspondence table WT;

FIG. 3 is an illustration depicting exemplary content of the edge-adjacent correspondence table ET;

FIG. 4 is a flowchart depicting the flow of a scanned image printing process by the printing system 10 of the present embodiment;

FIGS. 5A and 5B are illustrations depicting the original document OD used in the present embodiment, and a scanned image SI representing the scanned image data SID;

FIG. 6 is a flowchart depicting the flow of the area width inference process;

FIG. 7 is an illustration depicting the concept behind the area width inference process;

FIG. 8 is a flowchart depicting the flow of the dot data generation process with area width taken into consideration;

FIGS. 9A and 9B are illustrations depicting examples of dot formation states that have been determined through dot data generation processes with area width taken into consideration; and

FIG. 10 is a flowchart depicting the flow of the dot data generation process in a modified embodiment.

### DESCRIPTION OF THE PREFERRED EMBODIMENT

The embodiments of the present invention are described below in the indicated order:
A. Embodiment
B. Variations

### A. Embodiment

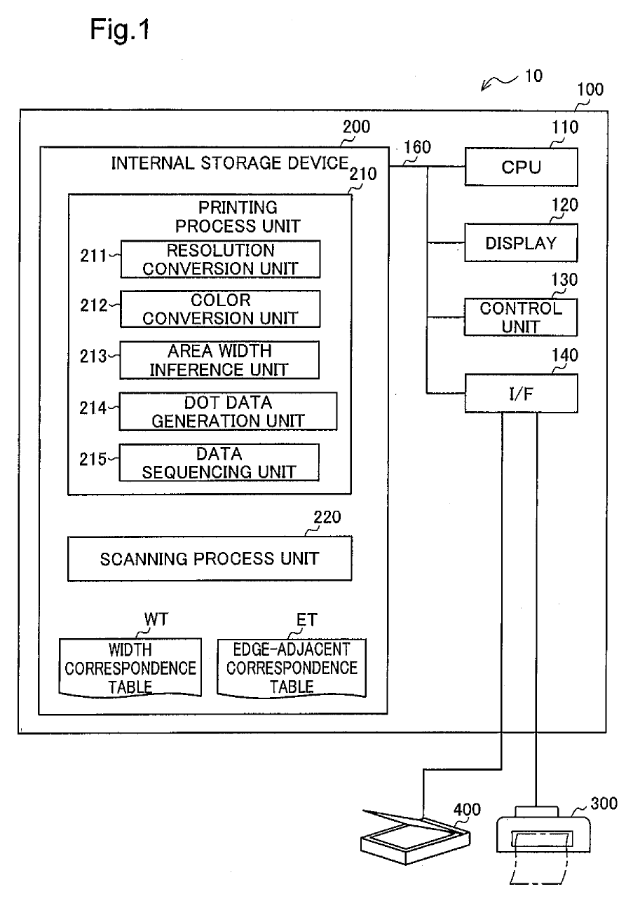

FIG. 1 is an illustration depicting schematically a configuration of a printing system according to an embodiment of the present invention. The printing system 10 of the present embodiment includes a personal computer 100 as an image processing apparatus; and a printer 300 and a scanner 400 that are connected to the personal computer 100.

The printer 300 is an ink-jet printer that carries out printing by jetting drops of ink onto a printing medium such as paper to form ink dots. The printer 300 of the present embodiment is adapted to carry out printing using ink dots of three different sizes (starting from the largest, “large dots,” “medium dots,” and “small dots”) of four different inks (cyan (C), magenta (M), yellow (Y), and black (K)).

The scanner 400 is an image scanner adapted to scan (i.e. to image) linear images (text and graphics) or pictures on an original with imaging elements, and to generate scanned image data.

The computer 100 includes a CPU 110, a display 120 such as an LCD monitor, a control unit 130 such as keyboard and mouse, an interface (I/F) 140, and an internal storage device 200 such as ROM and RAM. The elements of the computer 100 are interconnected via a bus 160.

The interface 140 is connected via cables to external devices such as the printer 300 and the scanner 400, and carries out exchange of data and information with the external devices. For example, the interface 140 supplies the printer 300 with print data for printing an image. The interface 140 also acquires scanned image data from the scanner 400. The interface 140 may also be connected to a network so as to enable exchange of data and information to take place over the network.

A printing process unit 210 and a scanning process unit 220 are stored in the internal storage device 200. The printing process unit 210 is a computer program for the purpose of controlling the printer 300 and printing images on the basis of image data. The scanning process unit 220 is a computer program for the purpose of controlling the scanner 400 and generating scanned image data through scanning of an original document. The CPU 110 executes a scanned image printing process, discussed later, by loading and executing these programs from the internal storage device 200.

The printing process unit 210 includes a resolution conversion unit 211, a color conversion unit 212, an area width inference unit 213, a dot data generation unit 214, and a data sequencing unit 215. The resolution conversion unit 211 converts the resolution of input image data to a resolution (print resolution) appropriate for processing starting with processing by the color conversion unit 212. The color conversion unit 212 converts the resolution-converted image data to image data of tones represented by the ink colors (CMYK) used for printing by the printer 300.

The area width inference unit 213, acting on the basis of scanned image data that has been generated by scanning of an original document containing linear images (text and graphics), infers width in prescribed directions at a prescribed location of a linear image in the original. Here, the prescribed directions are the horizontal direction and the vertical direction. Linear images in the original are represented in black. In the present embodiment, some or all of a linear image in the original is equivalent to the specific area taught in the present invention; black is equivalent to the specific color taught in the present invention. The method of inferring width by the area width inference unit 213 will be described in detail later.

On the basis of the tone values in the image data, the dot data generation unit 214 generates dot data that indicates ink dot formation states on the printing pixels. The dot data generation unit 214 in the present embodiment is equivalent to the dot formation state determining unit taught in the present invention. The method of dot data generation by the dot data generation unit 214 will be described in detail later.

The data sequencing unit 215 sequences the generated dot data, and outputs it as print data. The print data that has been generated by the printing process unit 210 is supplied to the printer 300 via the interface 140. The print data includes dot data that represents ink dot recording states for pixels on main scan lines at the print resolution; and sub-scan feed distance data that specifies the feed distance for sub-scanning.

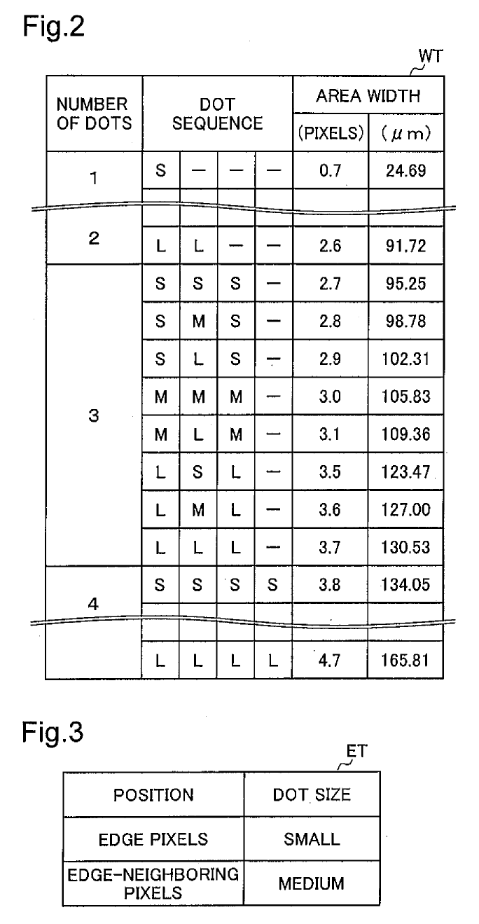

Within the internal storage device 200 are stored a width correspondence table WT and an edge-adjacent correspondence table ET. FIG. 2 is an illustration depicting exemplary content of a width correspondence table WT. The width correspondence table WT is a table that shows correspondence relationships between a plurality of dot sequences (these are combinations of dots along a prescribed direction) to the width, in the same direction, of dot areas composed of dots that have been formed on the printing medium in accordance with those dot sequences (i.e. width along the dot sequence direction). In FIG. 2, dot area width is expressed both as an absolute value of length (in μm units) and as a ratio of the width to pixel pitch. For example, for a dot area formed by a medium dot, a large dot, and a medium dot lined up in that order, the width would be 109.36 μm (or 3.1 times the dot pitch). In the present embodiment, because linear images in the original document are represented in black, the width correspondence table WT shows correspondence relationships between dot sequences and dot area widths for black dots. In the width correspondence table WT of the present embodiment, only correspondence relationships between dot sequences and dot area widths for dot sequences of from one to four dots are defined; correspondence relationships for dot sequences of five or more dots are not defined. The internal storage device 200 of the present embodiment in which the width correspondence table WT is stored is equivalent to the storage taught in the present invention.

FIG. 3 is an illustration depicting exemplary content of the edge-adjacent correspondence table ET. The edge-adjacent correspondence table ET defines dot placement on pixels in the edge zones of a linear image in a scanned image that represents scanned image data. In the present embodiment, “edge-adjacent pixels” refers to both edge pixels situated at edges per se, and edge-neighboring pixels that neighbor edge pixels and lie inwardly therefrom in the line drawing. As shown in FIG. 3, in the edge-adjacent correspondence table ET, small dots are assigned to edge pixels, and medium dots are assigned to edge-neighboring pixels.

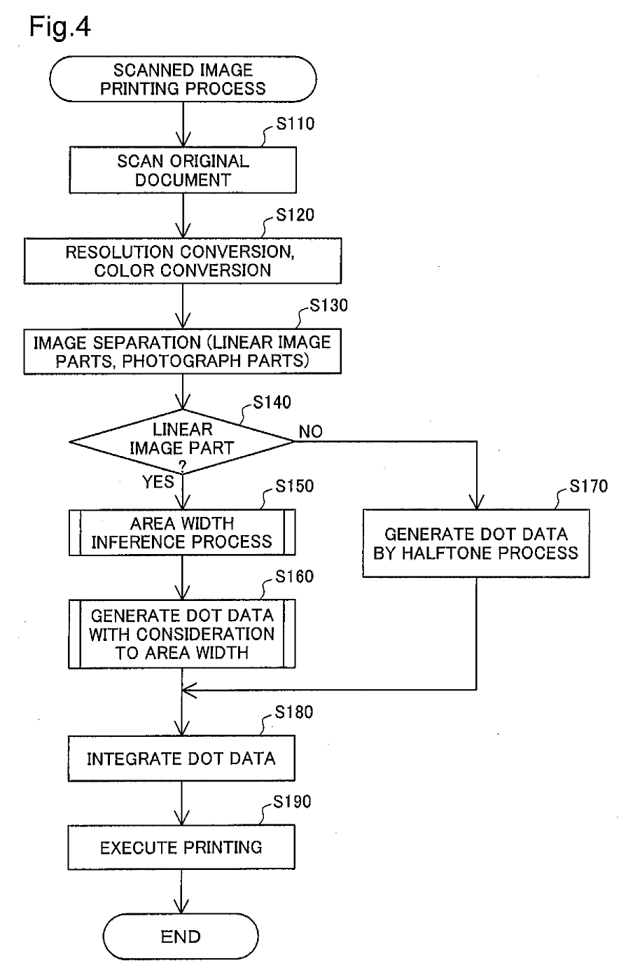

FIG. 4 is a flowchart depicting the flow of a scanned image printing process by the printing system 10 of the present embodiment. The scanned image printing process is a process by which the printer 300 prints an image on the basis of scanned image data that has been generated by scanning of an original document by the scanner 400.

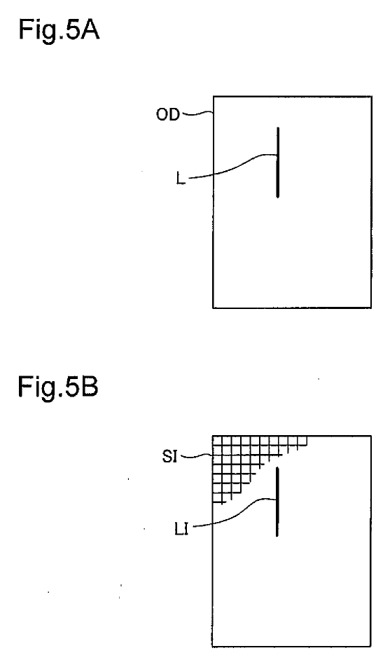

In Step S110, the scanning process unit 220 (FIG. 1) controls the scanner 400 to scan an original document OD and generate scanned image data SID. FIGS. 5A and 5B are illustrations depicting the original document OD used in the present embodiment, and a scanned image SI representing the scanned image data SID. As depicted in FIG. HA, the original document OD contains a linear image L. The linear image L is a specific color area represented by the specific color black. Portions of the original document OD apart from the linear image L are the background color of the original document OD (i.e. white). As depicted in FIG. 5B, the scanned image SI representing the scanned image data SID is an image composed of a plurality of pixels in accordance with the scanning resolution of the scanner 400, and includes a linear image picture LI representing the linear image L. In the present embodiment, the scanned image data SID is assumed to be image data in which the tone values of the pixels are represented in the RGB color system. The scanned image data SID generated in this way is acquired by the computer 100 via the interface 140, and saved to the internal storage device 200.

In Step S120 (FIG. 4), the resolution conversion unit 211 (FIG. 1) converts the resolution of the scanned image data SID so that it matches the resolution during printing by the printer 300 (the print resolution), while the color conversion unit 212 performs color conversion processing of the resolution-converted scanned image data SID. The scanned image data SID is thereby transformed to image data having the print resolution and represented in the CMYK color system.

In Step S130 (FIG. 4), the printing process unit 210 (FIG. 1) separates the scanned image data SID into linear image parts that represent linear images, and photograph parts that represent images such as photographs. Since linear image parts of scanned image data SID are essentially composed of black and white only, separation of linear image parts and photograph parts can be accomplished, for example, through inspection of saturation or luminance variation of pixels values of the scanned image data SID. The scanned image SI representing the scanned image data SID shown in FIG. 5B is entirely a linear image parts containing no photograph parts.

For photograph parts in scanned image data SID, the normal halftone process (e.g. a threshold process employing a dither matrix) is carried out by the dot data generation unit 210 in order to generate dot data (Step S140: No, Step S170).

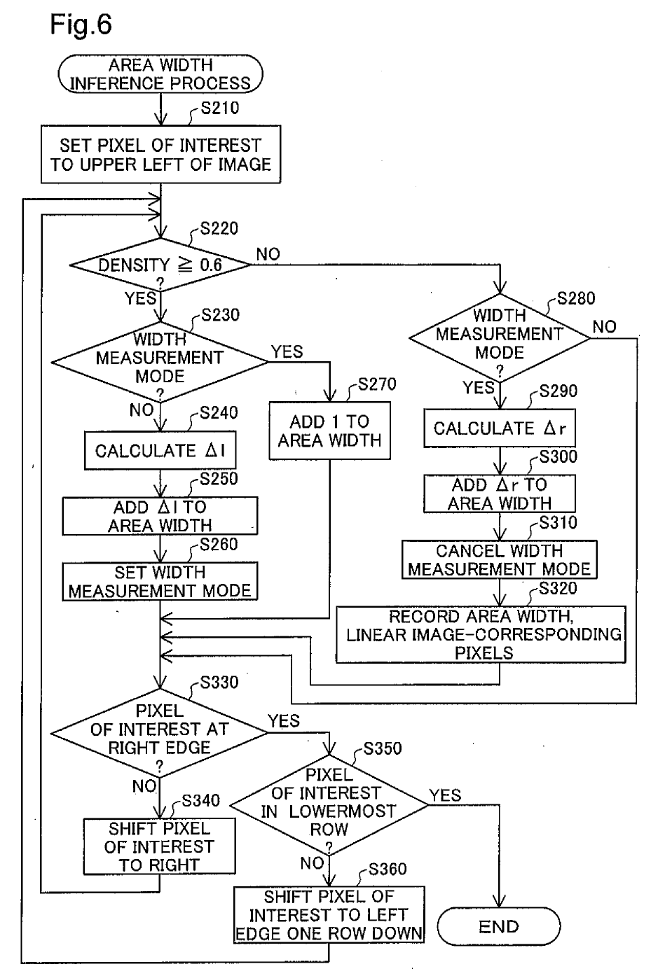

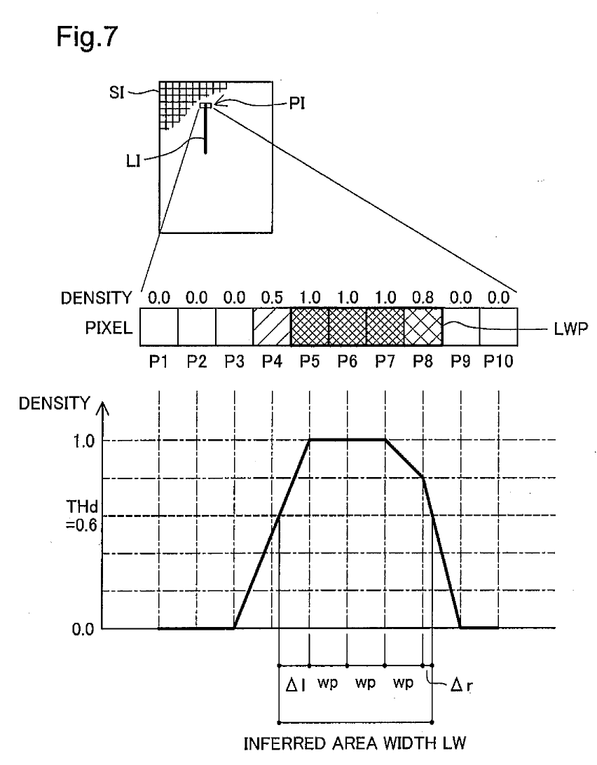

On the other hand, for linear image parts in scanned image data SID, an area width inference process (Step S140: Yes, Step S150) is carried out by the area width inference unit 213 (FIG. 1). FIG. 6 is a flowchart depicting the flow of the area width inference process. FIG. 7 is an illustration depicting the concept behind the area width inference process. FIG. 7 depicts in enlarged view ten pixels (P1 to P10) lined up in the horizontal direction and making up an image section PI that includes part of the linear image picture LI in the scanned image SI that is represented by the scanned image data SID, together with density values of pixels where white has been assigned density of 0.0 and black has been assigned density of 1.0. Also shown in FIG. 7 is a graph of density values at each location along the horizontal direction, calculated through linear interpolation carried out on the assumption that density value of each pixel represents the density value of that pixel at its center location along the horizontal direction.

As shown in FIG. 7, in the present embodiment, in the density distribution for each location along the horizontal direction, the section in which density values are equal to or greater than a threshold value THd (=0.6) is inferred to be a section corresponding to the linear image L in the original document OD; and the length of this section is inferred to be the width of the linear image L along the horizontal direction (hereinafter termed the “inferred area width LW”). The inferred area width LW is calculated using Expression (1) below, where K denotes the number of combinations of two neighboring pixels both having density values of ≧0.6, and wp denotes the pixel pitch (width of pixels).

LW=(K+Δ1+Δr)×wp (1)

In the above Expression (1), Δ1 denotes the section at the left end that is less than the pixel pitch wp in the inferred area width LW and is represented by Expression (2) below, where D[N] denotes density of the N-th pixel going from the left side towards the right side in the horizontal direction, and where D[N−1]<0.6 and D[N]≧0.6.

Δ1=1−(0.6−D[N]−1)/(D[N]−D[N−1]) (2)

Analogously, the above Expression (1), Δr denotes the section at the right end that is less than the pixel pitch wp in the inferred area width LW and is represented by Expression (3) below, where D[M] denotes density of the M-th pixel going from the right side towards the left side in the horizontal direction, and where D[M]<0.6 and D[M+1]≧0.6.

Δr=1−(0.6−D[M])/(D[M+1]−D[M]) (3)

In the example of FIG. 7, there are a total of three combinations of two neighboring pixels both having density values of ≧0.6, namely, the combination of P5 and P6, the combination of P6 and P7, and the combination of P7 and P8, and therefore the value of K is 3. Thus, the inferred area width LW will be a value derived by multiplying the pixel pitch wp by the sum of 3, Δ1, and Δr.

In the area width inference process (FIG. 6), a pixel of interest is set in a sequential manner going from the pixel in the upper left corner to the pixel in the lower right corner of the scanned image SI represented by the scanned image data SID (see FIG. 5B), and processing according to the density of the pixel of interest is carried out. Because the section outside the linear image picture LI of the scanned image SI represented by the scanned image data SID is a section corresponding to the background color (white) of the original document OD (see FIG. 5A), density values of pixels in this section are approximate 0.0. Thus, between the point in time that the area width inference process has been initiated and the pixel at the upper left corner of the scanned image SI represented by the scanned image data SID has been initially set as the pixel of interest (Step S210) and the point in time that the pixel of interest shifts into proximity to the linear image picture LI, the density value of the pixel of interest is determined to be less than 0.6 (Step S220: No in FIG. 6). Because the mode has not been set to width measurement mode (discussed later) at this point in time, it is determined that the mode is not the width measurement mode (Step S280: No). In this case, no processing is carried out in relation to the pixel of interest, and where the pixel of interest is not located at the right edge of the scanned image SI represented by the scanned image data SID (Step S330: No), the pixel of interest is shifted one to the right (Step S340); or where the pixel of interest is located at the right edge of the scanned image SI represented by the scanned image data SID (Step S330: Yes), and moreover the pixel of interest is not located in the lowermost row of the scanned image SI represented by the scanned image data SID (Step S350: No), the pixel of interest is shifted to the left end of the next row below (Step S360).

Through repeated shifting of the pixel of interest in this manner, the pixel of interest shifts into proximity to the linear image picture LI (shift to the location of pixel P5 shown in FIG. 7), whereupon it is determined for the first time that the density value is ≧0.6 (FIG. 6 Step S220: Yes). Because the mode has not yet been set to width measurement mode at this point in time, it is determined that the mode is not the width measurement mode (Step S230: No). At this point, the area width inference unit 213 calculates Δ1 on the basis of Expression (2) above (Step S240), and adds the calculated Δ1 to the area width (Step S250). The area width inference unit 213 also performs mode setting to width measurement mode (Step S260).

Next, when the pixel of interest shifts one to the right to pixel P6 shown in FIG. 7, it is determined that the density value is ≧0.6 (FIG. 6 Step S220: Yes); and since at this point the mode has been set to the width measurement mode, it is determined that the mode is the width measurement mode (Step S230: Yes). At this time, the area width inference unit 213 (FIG. 1) adds “1” to the area width (Step S270).

Analogously, when the pixel of interest shifts one more to the right to pixel P7 shown in FIG. 7, or when the pixel of interest shifts one more to the right to pixel P8, it is determined that the density value is ≧0.6 (Step S220: Yes in FIG. 6) and that the mode is the width measurement mode (Step S230: Yes), whereupon the area width inference unit 213 (FIG. 1) adds “1” to the area width (Step S270).

When the pixel of interest shifts one more to the right to pixel P9 shown in FIG. 7, it is determined that the density value is less than 0.6 (Step S220: No in FIG. 6), and that the mode is the width measurement mode (Step S280: Yes). At this time, the area width inference unit 213 (FIG. 1) calculates Δr on the basis of Expression (3) above (Step S290), and adds the calculated Δr to the area width (Step S300). Additionally, the area width inference unit 213 cancels the width measurement mode (Step S310).

In the above manner, the process necessary to calculate the inferred area width LW of the linear image picture LI at the locations of the ten pixels shown in FIG. 7 is brought to completion. Specifically, the inferred area width LW is calculated through multiplication of the pixel pitch wp by the sum of Δ1, (1×3), and Δr that were added to area width in Steps S250, S270, and S300 of FIG. 6. The area width inference unit 213 then records the calculated inferred area width LW to a prescribed location of the internal storage device 200, and also records the locations of linear image-corresponding pixels LWP (Step S320). Here, the linear image-corresponding pixels LWP are the pixels that were established as pixels corresponding to the linear image L of the original document OD in the scanned image SI represented by the scanned image data SID. As depicted in FIG. 7, the locations of the ends of the inferred area width LW need not necessarily coincide with locations of pixel edges. In the present embodiment, in the event that the location of the left edge of the inferred area width LW does not coincide with the location of a pixel edge, pixels equivalent to the number of dots in a dot sequence corresponding to the inferred area width LW (see FIG. 2) starting from the initial pixel (in the example of FIG. 7, P5) that is situated in its entirety to the right side of the location at the left edge of the inferred area width LW is established as the linear image-corresponding pixels LWP (in the example of FIG. 7, the four pixels starting with P5, i.e. the four pixels from P5 to P8).

By repeatedly executing the process described above in association with shift of the pixel of interest, inferred area width LW along the horizontal direction is calculated at each location of the linear image L of the original document OD. When the pixel of interest shifts to the pixel at the lower right corner of the scanned image SI represented by the scanned image data SID, it is determined that pixel of interest is situated at the lower right corner of the scanned image SI represented by the scanned image data SID (FIG. 6 Step S330: Yes) as well as being situated in the lowermost row of the scanned image SI represented by the scanned image data SID (Step S350: Yes), whereupon the area width inference process is terminate. In FIGS. 6 and 7, an area width inference process for calculating inferred area width LW along the horizontal direction was described; in Step S150 of FIG. 4, an area width inference process for calculating inferred area width LW along the vertical direction as well is carried out by a method analogous to the method shown in FIGS. 6 and 7. Thus, width is inferred along the horizontal and vertical directions at each location of the linear image L in the original document OD.

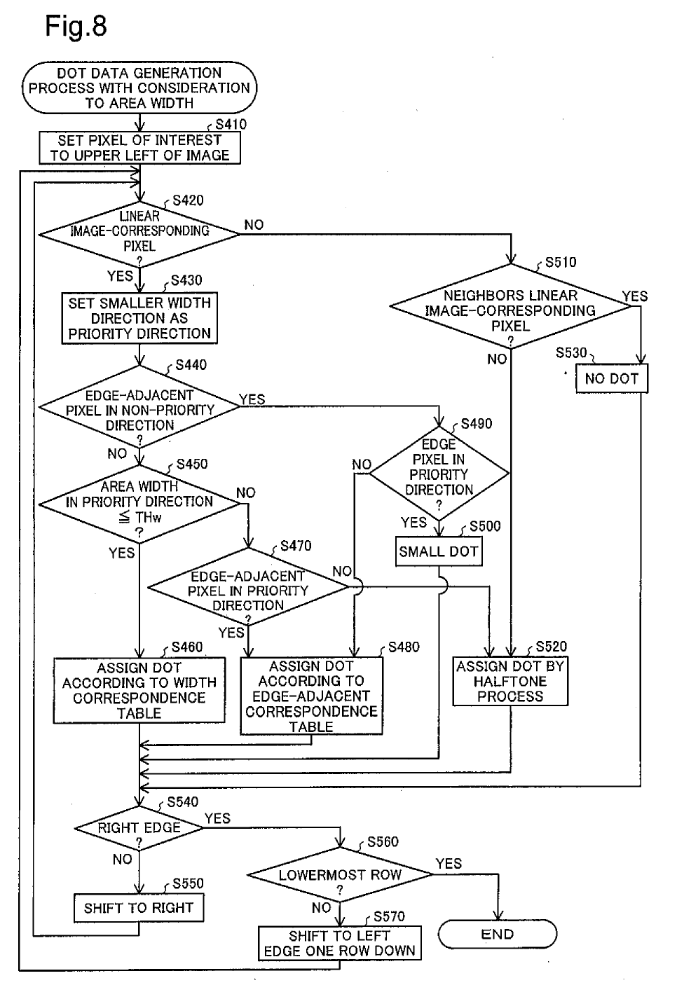

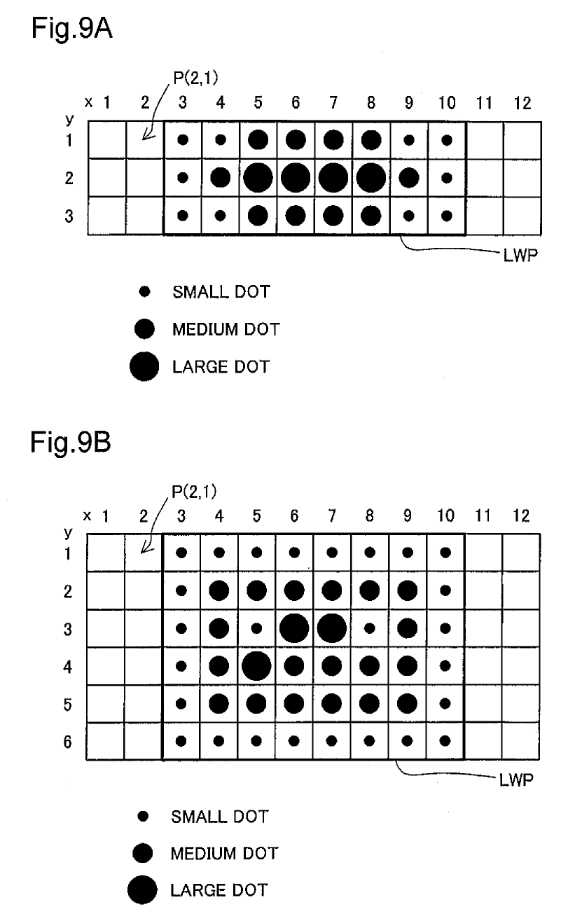

) Once the area width inference process (Step S150 of FIG. 4) has terminated the dot data generation unit 214 (FIG. 1) executes a dot data generation process (Step S160) with area width taken into consideration. FIG. 8 is a flowchart depicting the flow of the dot data generation process with area width taken into consideration. FIGS. 9A and 9B are illustrations depicting examples of dot formation states that have been determined through dot data generation processes with area width taken into consideration. In the following description, pixels in the examples shown in FIGS. 9A and 9B shall be referred to as P(x, y), using the horizontal direction coordinate x and the vertical direction coordinate y of each of the pixels shown in the drawing. In FIGS. 9A and 9B, linear image-corresponding pixels LWP that were established in the area width inference process are shown bordered by heavy lines.

In the dot data generation process with area width taken into consideration depicted in FIG. 8, in a similar manner to the area width inference process shown in FIG. 6, the pixel at the upper left corner of the scanned image SI represented by the scanned image data SID is set as the initial pixel of interest (Step S410 of FIG. 8), subsequently setting the pixel of interest in a sequential manner to each pixel until reaching the pixel at the lower right corner (see Steps S540 to S570), while determining dot formation state on the pixel of interest. When the pixel of interest has shifted, for example, to pixel P(1, 1) in FIG. 9A, it is determined that the pixel of interest is not a pixel that neighbors a linear image-corresponding pixel LWP (Step S510: No). In this case, the dot data generation unit 214 (FIG. 1) determines the dot formation state by the normal halftone process (e.g. a threshold process with a dither matrix) (Step S520). Because pixels that are neither linear image-corresponding pixels LWP nor neighboring linear image-corresponding pixels LWP, they are considered as pixels corresponding to the section outside the linear image L of the original document OD, and as a result of the halftone process, “form no dot” dot formation status is set for such pixels.

When the pixel of interest has shifted to pixel P(2, 1) of FIG. 9A, after it has been determined that the pixel of interest is not a linear image-corresponding pixel LWP (FIG. 8 Step S420: No), it is determined that the pixel of interest is a pixel neighboring a linear image-corresponding pixel LWP (Step S510: Yes). In this case, the dot data generation unit 214 (FIG. 1) sets the dot formation status to “form no dot” on the pixel (Step S530). As shown in the example of FIG. 7, in some instances a pixel neighboring a linear image-corresponding pixel LWP does not have a density value that is essentially 0.0, and if the dot formation state of such a pixel is allowed to be determined by the halftone process there is a possibility that a dot is placed on the pixel. In the present embodiment, by setting the dot formation status to “form no dot” on pixels that neighbor linear image-corresponding pixels LWP, reproduction of the width of the linear image L that appears in the original document OD can be accomplished by dots placed on linear image-corresponding pixels LWP.

When the pixel of interest has shifted to pixel P(3, 1) of FIG. 9A, it is determined that the pixel of interest is a linear image-corresponding pixel LWP (FIG. 8 Step S420: Yes). At this point, the dot data generation unit 214 (FIG. 1) sets as the priority direction either the horizontal direction or in the vertical direction, whichever has the smaller width within the inferred area width LW recorded in relation to the pixel in question (Step S430). For the pixel P(3, 1) of FIG. 9A, the vertical direction is set as the priority direction. Of the horizontal direction and the vertical direction, the direction that has not been set as the priority direction shall be termed the non-priority direction. Subsequently, it is determined whether the pixel is an edge-adjacent pixel in the non-priority direction (Step S440). As noted, edge-adjacent pixels refer to both edge pixels situated at edges per se, and edge-neighboring pixels that neighbor edge pixels to the inward side of the linear image. For the pixel P(3, 1) of FIG. 9A, it is determined that the pixel of interest is an edge-adjacent pixel in the non-priority direction (the horizontal direction) (Step S440: Yes). Once it has been determined that the pixel of interest is an edge-adjacent pixel in the non-priority direction, it is additionally determined whether the pixel of interest is an edge pixel in the priority direction (Step S490). For the pixel P(3, 1) of FIG. 9A, it is determined that the pixel of interest is an edge pixel in the priority direction (the vertical direction) (Step S490: Yes). In this case, the dot data generation unit 214 (FIG. 1) sets the dot formation status to “form a small dot” on the pixel in question (Step S500).

When the pixel of interest now shifts to pixel P(4,1) of FIG. 9A, as with the shift to P(3, 1), it is determined that the pixel of interest is a linear image-corresponding pixel LWP (Step S420: Yes), that it is an edge-adjacent pixel in the non-priority direction (the horizontal direction) (Step S440: Yes), and that it is an edge pixel in the priority direction (the vertical direction) (Step S490: Yes); accordingly the dot formation status is set to “form a small dot” (Step S500).

On the other hand, when the pixel of interest has shifted to pixel P(2, 3) or P(2, 4) of FIG. 9A, after it has been determined that the pixel of interest is a linear image-corresponding pixel LWP (Step S420: Yes) and that it is an edge-adjacent pixel in the non-priority direction (the horizontal direction) (Step S440: Yes), it is then determined not to be an edge pixel in the priority direction (the vertical direction) (Step S490: No). In this case, the dot data generation unit 214 (FIG. 1) assigns a dot to the pixel in accordance with the edge-adjacent correspondence table ET in order to set the dot formation status for the pixel in question (Step S480). Thus, because the pixel P(2, 3) is an edge pixel along the horizontal direction, its dot formation status is set to “form a small dot”; and because the pixel P(2, 4) is an edge-adjacent pixel along the horizontal direction, dot formation status for it is set to “form a medium dot.”

When the pixel of interest has shifted to pixel P(5, 1) of FIG. 9A, after the pixel of interest has been determined to be a linear image-corresponding pixel LWP (FIG. 8 Step S420: Yes), it is determined not to be an edge-adjacent pixel in the non-priority direction (the horizontal direction) (Step S440: No). In this case, a determination is carried out as to whether the inferred area width LW in the priority direction is equal to or less than a prescribed threshold value THw (Step S450). Here, the prescribed threshold value THw is the maximum value of area width specified in the width correspondence table WT (FIG. 2). In the event that the pixel of interest is situated at pixel P(5, 1) of FIG. 9A, as will be understood from the fact that there are three contiguous linear image-corresponding pixels LWP along the priority direction (vertical direction) at the location of the pixel of interest, it is determined that the inferred area width LW is equal to or less than the prescribed threshold value THw (Step S450: Yes). In this case, the dot data generation unit 214 (FIG. 1) assigns a dot to the pixel in accordance with the width correspondence table WT (FIG. 2) in order to set the dot formation status for the pixel in question (Step S460). Specifically, the area width that most closely approximates the inferred area width LW is selected from among the area widths specified in the width correspondence table WT, and a dot is assigned in accordance with the dot sequence that has been associated with the selected area width. For example, for pixel P(5, 1) of FIG. 9A, where the inferred area width LW in the vertical direction is 109 μm, the dot sequence (the sequence medium dot, large dot, medium dot in that order) associated with the area width that most closely approximates the inferred area width LW is selected from the width correspondence table WT, and a medium dot is assigned to the pixels at the ends of the linear image-corresponding pixels LWP. In this way, the width correspondence table WT is a table containing associations of inferred area width LW with dot sequences.

When the pixel of interest has shifted to pixel P(5, 2) of FIG. 9A, it is determined that the pixel of interest is a linear image-corresponding pixel LWP (FIG. 8 Step S420: Yes), and that the inferred area width LW in the priority direction is equal to or less than the prescribed threshold value THw (Step S450: Yes). Because the pixel P(5, 2) of FIG. 9A is the second (center) pixel of the linear image-corresponding pixels LWP, if for example the inferred area width LW in the vertical direction is 109 μm, the pixel is assigned a large dot in accordance with the dot sequence (the sequence medium dot, large dot, medium dot) associated with the area width that most closely approximates the inferred area width LW in the width correspondence table WT.

As discussed above, in instances where inferred area width LW in the priority direction (the-vertical direction in FIG. 9A) is equal to or less than the prescribed threshold value THw, dot formation status on pixels other than edge-adjacent pixels in the non-priority direction (the horizontal direction in FIG. 9A) (namely, pixels having x coordinates of 5 to 8 in FIG. 9A) is determined in accordance with the width correspondence table WT. Thus, at the locations of these pixels, the width of the dot area composed of dots in the printed result can be set to a value approximating the width of the linear image L. That is, in printing an image based on scanned image data SID that has been generated by scanning of an original document OD by the scanner 400, the width of the linear image L can be reproduced satisfactorily in the printed result.

Moreover, dot formation status edge-adjacent pixels in the non-priority direction (the horizontal direction in FIG. 9A) (namely, pixels having x coordinates of 3, 4, 9, and 10 in FIG. 9A) is determined in accordance with the edge-adjacent correspondence table ET. Thus, in relation to the non-priority direction, bleeding or thickening at edge portions can be reduced, and print quality can be improved.

In the example depicted in FIG. 9B as well, the vertical direction has been set as the priority direction. Thus, linear image-corresponding pixels LWP that are edge-adjacent pixels in the horizontal direction (namely, pixels having x coordinates of 3, 4, 9, and 10 in FIG. 9B) is assigned dots in accordance with the edge-adjacent correspondence table ET (Step S480 of FIG. 8). On the other hand, in relation to linear image-corresponding pixels LWP that are pixels other than horizontal direction edge-adjacent pixels (namely, pixels having x coordinates of 5 to 8 in FIG. 9B), as is understood from the fact that there are six contiguous linear image-corresponding pixels LWP in the priority direction (vertical direction), it is determined that the inferred area width LW in the priority direction is greater than the prescribed threshold value THw (Step S450: No). In this case, it is further determined whether the pixel of interest is an edge-adjacent pixel in the priority direction (Step S470); if determined to be an edge-adjacent pixel in the priority direction, the pixel is assigned a dot in accordance with the edge-adjacent correspondence table ET (FIG. 3) (Step S480). The above determination is made when the pixel of interest is situated at pixel P(5, 1) or P(5, 2) of FIG. 9B, with pixel P(5, 1) being assigned a small dot and pixel P(5, 2) being assigned a medium dot.

On the other hand, in relation to linear image-corresponding pixels LWP that are pixels other than edge-adjacent pixels in the horizontal direction (namely, pixels having x coordinates of 5 to 8 in FIG. 9B), if determined that the pixel of interest is not an edge-adjacent pixel in the priority direction (Step S470: No), dot formation status of the pixel in question is determined by the normal halftone process (Step S520). The above determination is made when the pixel of interest is situated at pixel P(5, 3) or P(5, 4) of FIG. 9B, with pixel P(5, 3) being assigned a small dot and pixel P(5, 4) being assigned a large dot, for example.

As described above, in instances in which inferred area width LW in the priority direction (the vertical direction in FIG. 9B) is greater than the prescribed threshold value THw, dot assignment in accordance with the width correspondence table WT (FIG. 2) is carried out. Where the inferred area width LW is relatively large, even if a difference should arise between the width of the linear image L in the original document OD and the width in the printed result, this difference is relatively difficult to perceive, and for this reason dot assignment in accordance with the width correspondence table WT is not carried out. Thus, a need for increased capacity of the width correspondence table WT can be avoided.

Moreover, dot formation states on edge-adjacent pixels in the priority direction (the vertical direction in FIG. 9B) and in the non-priority direction (the horizontal direction in FIG. 9B) (i.e. in FIG. 9B), pixels whose y coordinates are 1, 2, 5, and 6 and pixels whose x coordinates are 3, 4, 9, and 10) is determined in accordance with the edge-adjacent correspondence table ET. Thus, bleeding or thickening in edge portions can be reduced, and print quality can be improved.

### B. Variations

The present invention is not limited to the embodiments and aspects described above. The present invention may be worked in various aspects within limits that involve no departure from the spirit of the invention; for example, the following variations are possible.

### B1. Variation 1

As depicted in FIG. 7, in the preceding embodiment the value of the threshold value TTd in relation to density, used when calculating inferred area width LW, has been set to 0.6 where white has been assigned density of 0.0 and black has been assigned density of 1.0; however, the threshold value THd could be set to some other value, such as 0.7 or 0.5 for example.

Calculation of inferred area width LW may be carried out using some other tone value such as the luminance or G value, rather than the density value of each pixel.

### B2. Variation 2

In the preceding embodiment, the width correspondence table WT (FIG. 2) specifies correspondence relationships between dot sequence and area width in relation to dot sequences of from one to four dots; however, the width correspondence table WT may also specify correspondence relationships between dot sequence and area width in relation to dot sequences of five dots or more. Also, while a number n of dots has 3ⁿ possible dot sequences, there is no need for the width correspondence table WT to specify correspondence relationships between dot sequences and area width for all of these dot sequences. For example, from among all of the dot sequences it is acceptable to exclude asymmetrical sequences, and to investigate bumpiness at the edges in the actual printed result when selecting those dot sequences that are to be defined in the width correspondence table WT. Alternatively, in instances where there is some measure of dependence on the direction of movement of the carriage during printing, asymmetrical sequences may be selected. The correspondence relationships between dot sequence and area width in the width correspondence table WT shown in FIG. 2 are merely exemplary.

A separate regard width correspondence table WT may be prepared for each class of printing medium used in printing (e.g. plain paper or special ink-jet paper), for each class of dot material used in printing (e.g. dye based inks or pigment based inks), or for each direction of width of the linear image L (the direction corresponding to the main scanning direction or the direction corresponding to the sub-scanning direction). By so doing, the width of the linear image L in the original document OD can be better reproduced in the printed result according to the class of printing medium, the class of dot material, or the width of the linear image L.

### B3. Variation 3

In the scanned image printing process (FIG. 4) of the preceding embodiment, image separation is carried out subsequent to resolution conversion and color conversion; however, image separation may be carried out first, followed by resolution conversion and color conversion. In this case, color conversion may be carried out on photograph parts only, and not carried out on linear image parts.

In the scanned image printing process of the preceding embodiment, image separation need not be carried out. However, by carrying out image separation and then subjecting only the linear image parts to the area width inference process and the dot data generation process with area width taken into consideration, the process can be made more efficient and diminished printed image quality in photograph parts can be reduced.

### B4. Variation 4

In the dot data generation process with area width taken into consideration (FIG. 8) of the preceding embodiment, dots are not assigned to pixels that neighbor linear image-corresponding pixels LWP (i.e. pixels for which the determination in Step S510 is Yes) (Step S530); however, it is also acceptable to omit to assign dots not only to pixels that neighbor linear image-corresponding pixels LWP, but also to pixels situated away from linear image-corresponding pixels LWP by distances that are equal to no more than a prescribed value (e.g. by the equivalent of two pixels).

### B5. Variation 5

While the preceding embodiment described a scanned image printing process for an original document OD composed exclusively of white and the specific color black, the present invention may also be applicable to an original document OD composed exclusively of white and one color of dot used for printing (e.g. cyan, magenta, or yellow).

### B6. Variation 6

In the preceding embodiment, the image data is RGB data, but it not essential for the image data to be RGB data. In the preceding embodiment, the printer 300 carries out printing by forming dots of three different sizes using inks of the four colors CMYK, but it is acceptable for the printer 300 to instead carry out printing using inks of colors other than CMYK, or to carry out printing by forming dots of two (or four or more) different sizes.

### B7. Variation 7

In the preceding embodiment, the image processing device is constituted by a personal computer 100; however, it is possible for the present invention to be implemented analogously in other image processing devices besides a personal computer 100 which are adapted to carry out image processing through determination of states of dot formation. For example, the image processing device may be constituted by the printer 300.

In the preceding embodiment, some of the arrangements implemented through hardware may be replaced by software, and conversely some of the arrangements implemented through software may be replaced by hardware.

### B8. Variation 8

While the preceding embodiment described an example of a printer in which a head for jetting ink onto the printing medium moves in the main scanning direction, the present invention may also be implemented in a line head printer having a plurality of heads arrayed in the main scanning direction, with the heads being stationary.

### B9. Variation 9

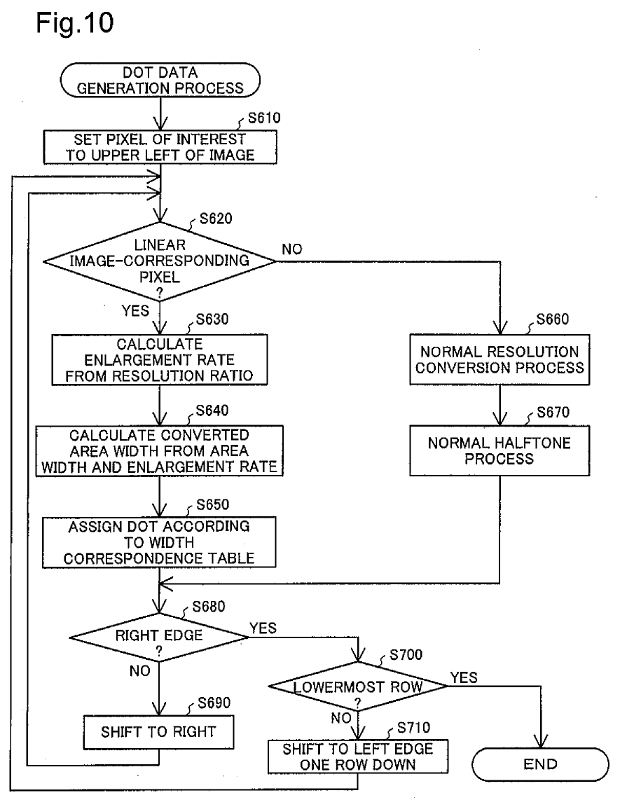

In a case where the scan resolution of the scanner 400 and the print resolution of the printer 300, are different, it is possible for the present invention to be implemented in resolution conversion. FIG. 10 is a flowchart depicting the flow of the dot data generation process in a modified embodiment. In the dot data generation process depicted in FIG. 10, for pixels that are not image-corresponding pixels LWP, the normal resolution conversion process (Step S660) and the normal halftone process (Step S670) are carried out. On the other hand, for the image-corresponding pixels LWP, an enlargement rate (or reduction rate) is calculated from the ratio of the scan resolution of the scanner 400 and the print resolution of the printer 300 (the resolution ratio) (Step S630); a converted inferred area width LW is calculated from the inferred area width LW and this enlargement rate (Step S640); and dot assignments are carried out in accordance with the width correspondence table WT (Step S650). According to the modified embodiment depicted in FIG. 10, execution of the resolution conversion process can be kept to a minimum, improving processing efficiency.

### B10. Variation 10

The width correspondence table WT (FIG. 2) in the present embodiment is a table that indicates correspondence relationships between a plurality of dot sequences that represent combinations of dots of a specific color along a prescribed direction, and width along the prescribed direction of dot areas composed of dots that have been formed on the printing medium in accordance with the dot sequences. For this reason, the present invention is not limited to cases of printing images on the basis of scanned images SI that a raster data, but is applicable generally to cases where it is intended that dot areas composed of dots in a printed image be of desired width, such as instances where the length/size of lines or graphics in the printed results are to have desired values during printing on the basis of vector data generated by CAD, for example.

What is claimed is:

1. An image processing apparatus for determining formation states of dots in printing an image based on an image data using dots of a plurality of sizes, comprising:
a storage configured to store a width correspondence table that indicates correspondence relationships between a plurality of dot sequences representing combinations of dots of specific color along a prescribed direction, and width along the prescribed direction of dot areas composed of dots that are formed on a printing medium in accordance with the dot sequences; and
a dot formation state determination unit configured to determine formation states of the dots based on the correspondence relationships indicated in the width correspondence table.

2. An image processing apparatus according to claim 1, wherein
the image data used for printing includes specific color area image data that is generated through imaging of a specific color area represented by the specific color,
wherein the image processing apparatus further comprises:
an area width inference unit configured to infer width along the prescribed direction at a prescribed location of the specific color area based on the specific color area image data, and
wherein the dot formation state determination unit determines formation states of the dots by selecting, according to the inferred width of the specific color area, the dot sequence to be formed at a location on the printing medium, which corresponds to the prescribed location of the specific color area.

3. An image processing apparatus according to claim 1, wherein
the specific color is black.

4. An image processing apparatus according to claim 3, wherein
the area width inference unit infers the width of the specific color area to be a length of a part in which interpolated tone values of the specific color area image data are equal to or greater than a prescribed threshold value.

5. An image processing apparatus according to claims 1, wherein
the storage stores the width correspondence table indicating class-specific correspondence relationships in relation to at least one class among: classes of printing medium used for printing; classes of dot material used for printing; and classes of the prescribed direction.

6. An image processing apparatus according to claims 1, wherein
the width correspondence table indicates correspondence relationships between dot sequence and dot area width in relation to dot sequences not exceeding a prescribed number of dots.

7. An image processing method of determining formation states of dots in printing an image based on an image data using dots of a plurality of sizes, comprising:
acquiring a width correspondence table that indicates correspondence relationships between a plurality of dot sequences representing combinations of dots of specific color along a prescribed direction, and width along the prescribed direction of dot areas composed of dots that are formed on a printing medium in accordance with the dot sequences; and
determining formation states of the dots based on the correspondence relationships indicated in the width correspondence table.

8. An image processing method according to claim 7, wherein
the image data used for printing includes specific color area image data that is generated through imaging of a specific color area represented by the specific color,
wherein the image processing method further comprises:
inferring width along the prescribed direction at a prescribed location of the specific color area based on the specific color area image data, and
wherein the determining is executed through selecting, according to the inferred width of the specific color area, the dot sequence to be formed at a location on the printing medium, which corresponds to the prescribed location of the specific color area.

9. An image processing method according to claim 7, wherein
the specific color is black.

10. An image processing method according to claim 9, wherein
the inferring is executed through inferring the width of the specific color area to be a length of a part in which interpolated tone values of the specific color area image data are equal to or greater than a prescribed threshold value.

11. An image processing method according to claims 7, wherein
the acquiring is executed through acquiring the width correspondence table indicating class-specific correspondence relationships in relation to at least one class among: classes of printing medium used for printing; classes of dot material used for printing; and classes of the prescribed direction.

12. An image processing method according to claims 7, wherein
the width correspondence table indicates correspondence relationships between dot sequence and dot area width in relation to dot sequences not exceeding a prescribed number of dots.

13. A computer program product for determining formation states of dots in printing an image based on an image data using dots of a plurality of sizes, the computer program product comprising:
a computer readable medium; and
a computer program stored on the computer readable medium, the computer program comprising:
a first program for causing a computer to acquire a width correspondence table that indicates correspondence relationships between a plurality of dot sequences representing combinations of dots of specific color along a prescribed direction, and width along the prescribed direction of dot areas composed of dots that are formed on a printing medium in accordance with the dot sequences; and
a second program for causing a computer to determine formation states of the dots based on the correspondence relationships indicated in the width correspondence table.

14. A printer that prints an image based on an image data using dots of a plurality of sizes, comprising:
a storage configured to store a width correspondence table that indicates correspondence relationships between a plurality of dot sequences representing combinations of dots of specific color along a prescribed direction, and width along the prescribed direction of dot areas composed of dots that are formed on a printing medium in accordance with the dot sequences;
a dot formation state determination unit configured to determine formation states of the dots based on the correspondence relationships indicated in the width correspondence table; and
a printing unit configured to form the dots on the printing medium based on the determined formation states of the dots to print an image.
